(19) United States
(12) Patent Application Publication
(10) Pub. No.: US 2008/0316935 A1
(43) Pub. Date: Dec. 25, 2008

(54) GENERATING A NODE-B CODEBOOK

(75) Inventors: Erdem Bala, Farmingdale, NY (US); Robert Lind Olesen, Huntington, NY (US); Kyle Jung-Lin Pan, Smithtown, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/136,156

(22) Filed: Jun. 10, 2008

Related U.S. Application Data
(60) Provisional application No. 60/944,912, filed on Jun. 19, 2007.

(51) Int. Cl. H04L 12/26

(52) U.S. Cl. 370/252

(57) ABSTRACT

A method and apparatus generates a codebook and associated scheduling and control signaling. A plurality of channel combinations is generated for a plurality of wireless transmit receive units (WTRUs). The channel for each WTRU is quantized based on the WTRU codebook. A codebook for beamforming is generated for a plurality of WTRUs. The codebook includes a plurality of beamforming matrices. All possible beamforming matrices may be computed and the codebook may be quantized.

### CROSS REFERENCE TO RELATED APPLICATIONS

This application claims the benefit of U.S. Provisional Application No. 60/944,912 filed on Jun. 19, 2007, which is incorporated by reference as if fully set forth.

### FIELD OF INVENTION

The present invention is related to wireless communication systems.

### BACKGROUND

Third generation partnership project (3GPP) and 3GPP2 are considering long term evolution (LTE) for radio interface and network architecture. In a downlink communication of a wireless system where the Node-B has transmit antennas, Nₜ, and each mobile station is equipped with a single or multiple antennas, Nᵣ, a multiplexing gain may be achieved by transmitting to multiple wireless transmit receive units (WTRUs) simultaneously. This gain may be achieved by complex coding schemes, such as dirty paper coding, which are difficult to implement in practice.

A non-complex method that may be affectively implemented is called beamforming. In this method, the data stream of each WTRU is multiplied by a beamforming vector. Then, the resulting streams are summed and sent from the transmitter antennas. In the more general case, when multiple data streams are transmitted to each WTRU, the beamforming vector for each WTRU becomes a matrix and each data stream of each WTRU is multiplied with a column vector of the matrix.

The beamforming vectors may be designed to meet some optimality criteria. If these vectors are carefully selected by taking the spatial signatures of the WTRUs into consideration, the interference among different streams may be reduced or cancelled. One specific method to design the beamforming vectors is called zero-forcing beamforming. In this method, the beamforming vectors are chosen such that the interference among different data streams becomes zero. The beamforming vectors may be computed by inverting the composite channel matrix.

To compute the beamforming vectors, the channel state information of all WTRUs is required at the transmitter. The mobile stations estimate their channels and quantize the estimated channels by using a given quantization codebook. Then, the index of the selected element of the quantization codebook and a channel quality indicator (CQI) is sent to the transmitter.

To compute the beamforming vectors, the channel state information of all WTRUs is required at the transmitter. The mobile stations estimate their channels and quantize the estimated channels by using a channel quantization codebook. Quantizing the channels includes selecting the codebook element, which is a vector in this case, that best represent the normalized channel. Then, the index of the selected codebook element and a channel quality indicator (CQI) is fed back to the transmitter.

After the base station (Node-B) receives the information from the WTRUs, a WTRU selection process is implemented at the scheduler and the beamforming vectors for the selected WTRUs are computed. The WTRU selection process helps optimize the system capacity. After the beamforming vectors are computed, they are quantized according to a given codebook. The index from this codebook is transmitted to the mobile stations in the downlink control channel.

Zero-Forcing (ZF) Beamforming

A review of the ZF beamforming is provided. Assume that the Node-B has transmit antennas M and there are L number of active WTRUs, out of which K number of active WTRUs may be scheduled for simultaneous transmission. Also, assume that Node-B transmits a single data stream to each WTRU and that each WTRU has a single receive antenna. These assumptions are for illustration purposes only and may be generalized to multiple data streams for each WTRU and multiple receive antennas for each WTRU. In the more general case of multiple receive antennas at a wireless transmit receive unit (WTRU), there would be a combining vector at the receiver.

Let sₖ be the data symbol that is transmitted to the k^{th} WTRU, and Pₖ be the power allocated for the k^{th} WTRU. The data symbol for each WTRU is multiplied with a beamforming vector wₖ. Then, the transmitted signal from the Node-B is given by Equation (1) as the following:

$${\sum }_{k = 1}^{K} {P}_{k} {w}_{k} {s}_{k} . \qquad Equation ( 1 )$$

For the WTRU k, the received signal is per Equation (2):

$${y}_{k} = \sqrt{{P}_{k}} {h}_{k} {w}_{k} {s}_{k} + {\sum }_{j = 1 , j \neq k}^{K} \sqrt{{P}_{j}} {h}_{k} {w}_{j} {s}_{j} + {n}_{k} ; \qquad Equation ( 2 )$$

where hₖ is the channel from the WTRU k to the Node-B. The first part of Equation (2), \sqrt{Pₖ}hₖwₖsₖ, is the data stream transmitted to WTRU k; the second part,

$${\sum }_{j = 1 , j \neq k}^{K} \sqrt{{P}_{j}} {h}_{k} {w}_{j} {s}_{j} ,$$

is the data transmitted to other WTRUs: inter-WTRU or inter-stream interference; and the third part, nₖ, is noise. In ZF beamforming, the beamforming vectors are chosen such that multiplication of a channel from the WTRU k, hₖ and the beamforming vectors used for other WTRUs, wⱼ, is zero (i.e., hₖwⱼ=0 for k≠j). This condition guarantees that the interference from the other WTRUs' data on WTRU k is cancelled.

One way of accomplishing the zero inter-WTRU interference condition is to compute the beamforming vectors from the pseudo-inverse of the composite channel matrix. Define the composite channel matrix as H=[h₁^{T} h₂^{T} . . . h_{K}^{T}] and the composite beamforming matrix as W=[w₁ w₂ . . . w_{K}]. Then, the zero inter-WTRU interference condition may be satisfied if a beamforming matrix W is W=H^{†}=H^{H} (HH^{H})⁻¹ where H^{†} denotes the pseudo-inverse of H, and H^{H} denotes the Hermitian of H.

When the beamforming matrix W is computed in this manner, it is shown that the effective channel gain to the k^{th} WTRU is

$$\frac{1}{{‖ {w}_{k} ‖}^{2}} = \frac{1}{{[ {( {HH}^{H} )}^{- 1} ]}_{kk}}$$

where the subscript “kk” denotes the k^{th} diagonal element of the matrix. This shows that when H is poorly conditioned, the effective channel gain may be greatly reduced and degrades the performance. Therefore, to optimize the performance, the K out of L active WTRUs is selected such that the channels h of the selected WTRUs are nearly orthogonal and, at the same time, have large gains. Under these conditions, the performance of the ZF beamforming approaches achievable limits. If the channels of the selected WTRUs are highly correlated, then the performance is degraded. In an Orthogonal Frequency Division Multiple Access (OFDMA) system, the computation is repeated for every resource block or a number of resource blocks.

Channel Vector Quantization

To achieve the optimal performance of the ZF beamforming, the perfect channel state information of all WTRUs is required at the Node-B. This is achieved by the WTRU estimating the channel and feeding this information back to the Node-B. Due to the practical limits on the capacity of the feedback channel, the number of bits to represent the channel is limited. Therefore, the estimated channel is quantized according to a given codebook and then the index from the codebook is transmitted to the Node-B. Under these circumstances, the beamforming matrix W computed at the Node-B would not guarantee zero inter-WTRU interference due to the channel quantization error.

Assume that the codebook used for the channel quantization, called the WTRU codebook consists of N unit-norm vectors, and is denoted as C_{WTRU}={c₁, c₂, . . . , c_{N}}. Each WTRU first normalizes its channel h and then chooses the closest codebook vector that may represent the channel. Note that the normalization process loses the amplitude information and only the direction/spatial signature of the channel is retained. The amplitude information is transmitted in the CQI feedback.

Quantization is done according to the minimum Euclidian distance such that the quantized channel is per Equation (3):

$${\hat{h}}_{k} = {c}_{n} , n = arg {max}_{i = 1 , … , N} \vert {\tilde{h}}_{k} {c}_{i}^{H} \vert , \qquad Equation ( 3 )$$

where ĥₖ is the quantized channel which may be represented by the n^{th} codebook vector cₙ from C_{WTRU}, and \tilde{h}ₖ is the normalized channel. The WTRU feeds back the index n to the Node-B. The uncertainty due to the quantization error would also have implications on the CQI computation. In this case, each WTRU experiences some inter-WTRU interference and therefore may also consider interference when computing the CQI. Some measure of the signal to interference plus noise ratio (SINR) may be used for the CQI computation.

After Node-B receives the information from the WTRUs, first the WTRU selection process is ran. As a result of this process, K WTRUs are selected for transmission. With these K WTRUs, the beamforming matrix W is computed per Equation (4):

W=\hat{H}^{H}(\hat{H}\hat{H}^{H})⁻¹diag(p)^{1/2}, Equation (4)

where Ĥ=[ĥ₁^{T}, . . . , ĥ_{K}^{T}]^{T} is the composite channel matrix, and p=(p₁, . . . , p_{K})^{T} is the vector of power allocation coefficients that impose the power constraint on the transmitted signal. For equal power allocation,

$${p}_{k} = \frac{P}{K} .$$

Each beamforming vector is normalized so that ∥wₖ∥²=1.

Due to the channel quantization error, the condition hₖwⱼ=0, where k≠j is not satisfied because the beamforming matrix W is computed by using the ĥₖ and not hₖ. Given that the received signal at the WTRU k is

$${y}_{k} = \sqrt{{P}_{k}} {h}_{k} {w}_{k} {s}_{k} + {\sum }_{j = 1 , j \neq k}^{K} \sqrt{{P}_{j}} {h}_{k} {w}_{j} {s}_{j} + {n}_{k} ,$$

the SINR becomes:

$$S I N {R}_{k} = \frac{{p}_{k} {\vert {h}_{k} {w}_{k} \vert}^{2}}{{σ}^{2} + {\sum }_{i \neq k} {p}_{i} {\vert {h}_{k} {w}_{i} \vert}^{2}} , \qquad Equation ( 5 )$$

where σ² denotes the noise variance. To compute the exact SINR, the WTRU has to know the beamforming vectors in advance. This is not possible because the WTRU does not know the channels of the other WTRU's. However, it is known that the interference depends on the channel quantization error. By using this fact, the SINR is estimated by using various ways. For example, it has been shown that Equation (5) may be lower bounded by Equation (6):

$$E [ S I N {R}_{k} ] \geq \frac{{p}_{k} {‖ {h}_{k} ‖}^{2} {cos}^{2} {θ}_{k}}{1 + \frac{P}{M} {‖ {h}_{k} ‖}^{2} {sin}^{2} {θ}_{k}} ; \qquad Equation ( 6 )$$

where θₖ is the angle of the quantization error.

After the beamforming matrix W is computed, it has to be signaled to the WTRUs so that the WTRUs may compute the effective channel HW and receive the transmitted data. The set of all possible beamforming matrices constitute the Node-B codebook and is denoted as C_{NodeB}={W₁, W₂, . . . }. In the theoretical case where the channel vector h is not quantized and has an infinite number of values, the Node-B codebook would have an infinite number of matrices. On the other hand, when h is quantized, then the Node-B codebook consists of a limited set of matrices.

As an example, consider the case where the WTRU codebook size is 16 and the Node-B transmits to two WTRUs simultaneously. The composite quantized channel is then denoted as Ĥᵢⱼ=[ĥᵢ^{T}ĥⱼ^{T}]^{T}; i,j=1 . . . 16 where i≠j. The number of channel matrices with distinct combinations of quantized channel vectors in this case is

$$( \begin{matrix}16 \\ 2\end{matrix} ) = 120.$$

For each of these channel matrices, there is a beamforming matrix computed at the Node-B by using W=Ĥ^{H} (ĤĤ^{H})⁻¹. From this, it is seen that the Node-B codebook would consist of 120 beamforming matrices.

The possible combinations for the composite channel matrices Ĥ and the corresponding W are listed as an example in Table 1. Table 1 shows possible channel and beamforming matrices when the size of the WTRU codebook is 16 and Node-B transmits to two WTRUs.

TABLE 1

| Possible Channel | Beamforming Matrix |
|---|---|
| Ĥ₁ = [ĥ₁^{T}ĥ₂^{T}]^{T} | W₁ |
| Ĥ₂ = [ĥ₁^{T}ĥ₃^{T}]^{T} | W₂ |
| Ĥ₃ = [ĥ₁^{T}ĥ₄^{T}]^{T} | W₃ |
| . . . | . . . |
| Ĥ₁₅ = [ĥ₁^{T}ĥ₁₆^{T}]^{T} | W₁₅ |
| Ĥ₁₆ = [ĥ₂^{T}ĥ₃^{T}]^{T} | W₁₆ |
| Ĥ₁₇ = [ĥ₂^{T}ĥ₄^{T}]^{T} | W₁₇ |
| . . . | . . . |
| Ĥ₂₉ = [ĥ₂^{T}ĥ₁₆^{T}]^{T} | W₂₉ |
| Ĥ₃₀ = [ĥ₃^{T}ĥ₄^{T}]^{T} | W₃₀ |
| . . . | . . . |
| Ĥ₁₁₈ = [ĥ₁₄^{T}ĥ₁₅^{T}]^{T} | W₁₁₈ |
| Ĥ₁₁₉ = [ĥ₁₄^{T}ĥ₁₆^{T}]^{T} | W₁₁₉ |
| Ĥ₁₂₀ = [ĥ₁₅^{T}ĥ₁₆^{T}]^{T} | W₁₂₀ |

Table 1 indicates that a Node-B codebook of size 120 is possible and then the index of the computed W from this codebook is signaled to the WTRUs. But, this codebook size becomes large and would become larger as the number of WTRUs is increased. This increases the downlink control signaling overhead. For example, 120 matrices may be represented with 7 bits, which requires 75% more control channel capacity than the uplink control channel used for the WTRU codebook feedback. In addition to this, the memory requirements for larger codebooks would be large also.

The size of the Node-B codebook C_{NodeB}={W₁, W₂, . . . , W₁₂₀) may be reduced which would result in significant reduction in feedback overhead but without significantly affecting the performance. Therefore, it would be beneficial to provide a method for reducing codebook sizes and designing efficient Node-B codebooks, which results in an efficient scheduling and downlink control signaling scheme.

### SUMMARY

A method and apparatus for generating a codebook and associated scheduling and control signaling are disclosed. The method and apparatus can be used for a Multiple Input Multiple Output (MIMO) communication system. A plurality of channel combinations is generated for a plurality of WTRUs. The channel for each WTRU is quantized based on a WTRU codebook. A codebook for beamforming is generated for a plurality of WTRUs. The codebook includes a plurality of beamforming matrices. All possible beamforming matrices may be computed and the codebook may be quantized using a Generalized Lloyd Algorithm. Each of the channel combinations may be associated with one of the beamforming matrices in the codebook and the beamforming matrices may be updated iteratively.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a functional block diagram of a wireless transmit receive unit (WTRU) in accordance with the disclosure;

FIG. 2 shows an illustration of the mapping from the channel pairings to the quantized beamforming matrices;

FIG. 3 shows the correlations between all possible channel pairings;

FIG. 4 shows the performance resulting with the use of an efficient codebook design;

FIG. 5 is a flow diagram illustrating uplink control signalling; and

FIG. 6 is a flow diagram illustrating downlink control signalling.

### DETAILED DESCRIPTION OF THE PREFERRED EMBODIMENTS

When referred to hereafter, the terminology a wireless transmit/receive unit (WTRU) includes but is not limited to user equipment or “UE”, a mobile station, a fixed or mobile subscriber unit, a pager, a cellular telephone, a personal digital assistant (PDA), a computer, or any other type of user device capable of operating in a wireless environment. When referred to hereafter, the terminology “Node-B” includes but is not limited to a base station, a site controller, an access point (AP), or any other type of interfacing device capable of operating in a wireless environment.

Efficient Node-B codebook and associated scheduling and control signaling for downlink multi-user MIMO communication are described.

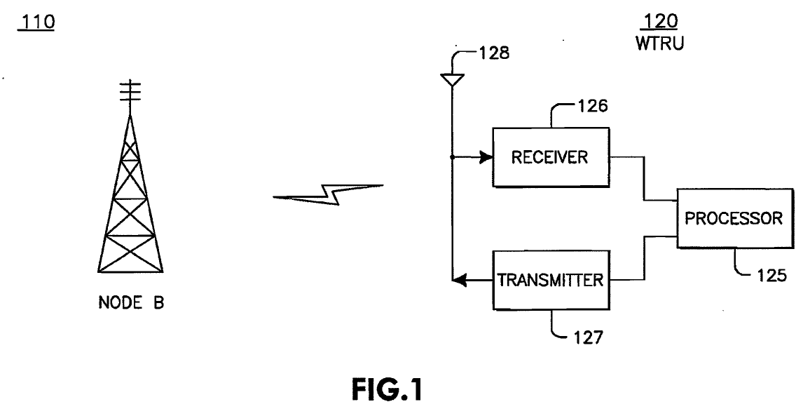

FIG. 1 is a diagram of a WTRU 120 configured to perform the method disclosed hereinafter. In addition to components included in a typical WTRU, the WTRU 120 includes a processor 125 configured to perform the disclosed method, a receiver 126 which is in communication with the processor 125, a transmitter 127 which is in communication with the processor 125, and an antenna 128 which is in communication with the receiver 126 and the transmitter 127 to facilitate the transmission and reception of wireless data. The WTRU wirelessly communicates with a base station (Node-B) 110.

Codebook Designs

In a first embodiment, an efficient codebook design is described. First, the original Node-B codebook is created by computing all possible W matrices. Then, this original codebook is quantized and a resulting codebook of a smaller size is created—a revised codebook. The revised codebook is known both to the Node-B and the WTRUs and is used for subsequent communications.

The quantization process is implemented according to some optimality criteria. The beamforming matrix for a given Ĥ is computed as W=Ĥ^{H} (ĤĤ^{H})⁻¹. This implies

$$\hat{H} W = [ \begin{matrix}1 & 0 \\ 0 & 1\end{matrix} ]$$

where the off-diagonal coefficients are zero. If the actual channel matrix were equal to the quantized channel, then the received data from two WTRUs would be as:

$$y [ \begin{matrix}{y}_{1} \\ {y}_{2}\end{matrix} ] = \hat{H} W [ \begin{matrix}{s}_{1} \\ {s}_{2}\end{matrix} ] + n = [ \begin{matrix}1 & 0 \\ 0 & 1\end{matrix} ] [ \begin{matrix}{s}_{1} \\ {s}_{2}\end{matrix} ] + n = [ \begin{matrix}{s}_{1} \\ {s}_{2}\end{matrix} ] + n , \qquad Equation ( 7 )$$

where

$$s = [ \begin{matrix}{s}_{1} \\ {s}_{2}\end{matrix} ]$$

is the data streams for the two WTRUs and n is the noise.

The coefficients that correspond to the inter-stream interference are nulled due to the ZF computation of the W. Because the actual channel differs from the quantized channel, the inter-WTRU interference is not cancelled. But, the information available at the Node-B about the channel is the quantized channel, so this information is used to design the Node-B codebook. Now, denote the quantized version of a beamforming matrix W as Ŵ. Similar to above, when Ŵ is used to compute ĤŴ, the off-diagonal coefficients are no longer zero and

$$\hat{H} \hat{W} = [ \begin{matrix}{α}_{1} & {β}_{1} \\ {β}_{2} & {β}_{2}\end{matrix} ] .$$

In this case, the received data is per Equation (8),

$$y = [ \begin{matrix}{y}_{1} \\ {y}_{2}\end{matrix} ] = [ \begin{matrix}{α}_{1} & {β}_{1} \\ {β}_{2} & {α}_{2}\end{matrix} ] [ \begin{matrix}{s}_{1} \\ {s}_{2}\end{matrix} ] + n = [ \begin{matrix}{α}_{1} {s}_{1} + {β}_{1} {s}_{2} \\ {α}_{2} {s}_{2} + {β}_{2} {s}_{1}\end{matrix} ] + n . \qquad Equation ( 8 )$$

From this, the signal-to-interference ratio (SIR) or the achievable capacity is computed because the values of the variables α₁, α₂, β₁, β₂ are known. The optimization criteria in the quantization process are based on measures such as SIR or the capacity.

The goal of the quantization process is to reduce the number of matrices in the Node-B codebook but also try to achieve some kind of optimality. For the quantization of the Node-B codebook, the following iterative algorithm is based on the generalized Lloyd algorithm. This process is run once off-line to design the Node-B codebook and then the resulting codebook is used at the transmitter and the receiver. Because the only information that is required is the quantized channel information, the algorithm is general and may be applied to any kind of channel.

Assume a list of all possible channel pairings Ĥᵢ, i=1, . . . 120 and begin with an initial Node-B codebook of size N such that the initial codebook consists of C_{NodeB}={Ŵ₁, Ŵ₂, . . . , Ŵ_{N}}. This codebook may be chosen from the beamforming matrices in the original Node-B codebook. In the examples, assume N is 16 or smaller.

In the first step of the algorithm, associate each of the 120 channel pairings with one of the N beamforming matrices in the Node-B codebook. The set of all channel pairings associated to a given beamforming matrix is called the region of that beamforming matrix and is denoted with R. The two criteria used here are maximizing the average SIR and the capacity.

For the SIR criterion, the region is defined as Equation (9),

Rᵢ={Ĥ:SIR(\hat{H}\hat{W}ᵢ)≧SIR(\hat{H}\hat{W}ⱼ),∀i≠j},i,j=1, . . . , N. Equation (9)

Further expansion of Equation (9) gives Equation (10):

$${R}_{i} = \{ \begin{matrix}H \text{:} \frac{{\sum }_{m = 1}^{2} {\vert {[ \hat{H} {\hat{W}}_{i} ]}_{m , m} \vert}^{2}}{{\sum }_{m , n = 1 ; m \neq n}^{2} \vert {[ \hat{H} {\hat{W}}_{i} ]}_{m , n} \vert} \geq \\ \frac{{\sum }_{m = 1}^{2} {\vert {[ \hat{H} {\hat{W}}_{j} ]}_{m , m} \vert}^{2}}{{\sum }_{m , n = 1 ; m \neq n}^{2} \vert {[ \hat{H} {\hat{W}}_{j} ]}_{m , n} \vert} , ∀ i \neq j\end{matrix} \} , \\ i , j = 1 , … N . \qquad Equation ( 10 )$$

Region Rᵢ is the set of all channel pairings that result in the largest average SIR when the beamforming matrix used for these channel pairings is Wᵢ.

Another more practical criterion is the capacity. In this case the region is given per equation (11),

Rᵢ=Ĥ:C(\hat{H}\hat{W}ᵢ)≧C(\hat{H}\hat{W}ⱼ),∀i≠j=1, . . . , N, Equation (11)

where C denotes the capacity. Equation (11) may be written as Equation (12)

$${R}_{i} = \{ \begin{matrix}\hat{H} \text{:} log 2 ( 1 + \frac{{\vert {[ \hat{H} {\hat{W}}_{i} ]}_{1 , 1} \vert}^{2}}{{N}_{0} + {\vert {[ \hat{H} {\hat{W}}_{i} ]}_{1 , 2} \vert}^{2}} ) + \\ log 2 ( 1 + \frac{{\vert {[ \hat{H} {\hat{W}}_{i} ]}_{2 , 2} \vert}^{2}}{{N}_{0} + {\vert {[ \hat{H} {\hat{W}}_{i} ]}_{2 , 1} \vert}^{2}} ) \geq \\ log 2 ( 1 + \frac{{\vert {[ \hat{H} {\hat{W}}_{j} ]}_{1 , 1} \vert}^{2}}{{N}_{0} + {\vert {[ \hat{H} {\hat{W}}_{j} ]}_{1 , 2} \vert}^{2}} ) + \\ log 2 ( 1 + \frac{{\vert {[ \hat{H} {\hat{W}}_{j} ]}_{2 , 2} \vert}^{2}}{{N}_{0} + {\vert {[ \hat{H} {\hat{W}}_{j} ]}_{2 , 1} \vert}^{2}} ) , \\ ∀ i \neq j\end{matrix} \} , \\ i , j = 1 , … N ; \qquad Equation ( 12 )$$

where N₀ is a constant, for example noise variance.

In the second step of the algorithm, the beamforming matrices are updated. To accomplish this, for each beamforming matrix, use the channel pairings that were associated with the beamforming matrix in the first step. For each of the N regions, the new beamforming matrix is computed per Equation (13), as follow:

$${\hat{W}}_{i} = \frac{1}{{L}_{i}} {\sum }_{n = 1}^{{L}_{i}} {{\hat{H}}_{n}^{H} ( {\hat{H}}_{n} {\hat{H}}_{n}^{H} )}^{- 1} , {\hat{H}}_{n} ∈ {R}_{i} , i = 1 , … , N ; \qquad Equation ( 13 )$$

where Lᵢ denotes the number of channel matrices in the i^{th} region. After all of the beamforming matrices are updated, go back to the first step and continue the algorithm until a stopping criterion is met. The algorithm may be stopped, for example, when the beamforming matrices converge and do not change anymore. The final set of beamforming matrices depend on the optimality criterion used and the initial set of beamforming matrices used in the first iteration of the algorithm. Selecting a good initial set and a proper optimality criterion improves the quality of the resultant codebook.

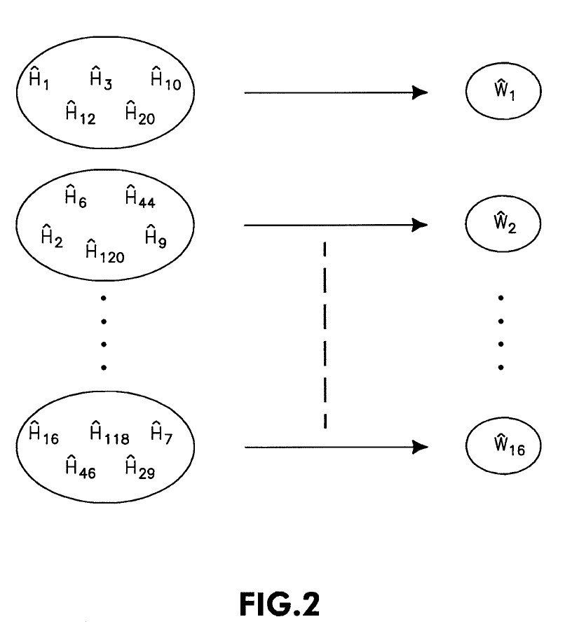

At the end of the quantization process, the result is a Node-B codebook of size N and a mapping based on the region that maps each possible channel pairing to one of the N beamforming matrices. For the example above, the 120 possible channel pairings are mapped to 16 matrices in the Node-B codebook. This mapping simplifies the scheduling process at the Node-B. When two WTRUs are scheduled for transmission, the composite quantized channel matrix is one of the 120 possibilities, and the corresponding beamforming matrix is found from a mapping table. The mapping table is a table that maintains the mapping as shown in FIG. 2. The actual number of channel pairings is in fact 120 times 2 because the columns in the channel matrix may be interchanged. In this case, the beamforming vectors in the corresponding matrix are also interchanged, so it is enough just to use 120 matrices for the codebook design. FIG. 2 shows an illustration of the mapping from the channel pairings to the quantized beamforming matrices.

As we have seen in the previous sections, after the Node-B receives the quantized channel and CQI information from the active WTRUs, it runs a WTRU selection algorithm to pair WTRUs whose channels are nearly orthogonal. This implies that WTRUs whose channels are highly correlated would not be selected for transmission.

Therefore, in a second embodiment, the channel pairings that have high correlation values are omitted. So, one method of reducing the size of the Node-B codebook is to restrict the possible channel pairings before computing the beamforming matrices. This approach would result in a smaller number of beamforming matrices. It is assumed that the WTRU codebook is a fast Fourier transform (FFT) based codebook. Due to the symmetrical properties of the FFT, the correlations between all possible channel pairings would also have a large symmetrical property.

For example, when the correlations of all possible channel pairings is, ρ=|ĥᵢ^{H}ĥⱼ|, where i, j=1, 2, . . . , 16, and i<j, it is seen that the 120 possible combinations may be grouped into six groups according to the correlation values. In each group, the correlation values of the channel pairings are exactly the same. These groups correspond to ρ=0, 0.1802, 0.2126, 0.2706, 0.3182, 0.6533, 0.9061. The number of channel pairings in these groups is 24, 16, 16, 16, 16, 16, and 16, respectively. For these correlation values, the channel pairings with large correlation values may never be selected for transmission. Therefore, omitting them in the Node-B codebook generation would reduce the size of the codebook without degrading the performance.

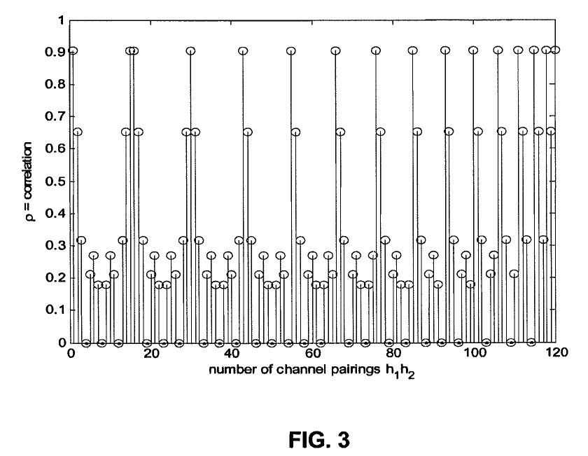

FIG. 3 illustrates the correlations of the possible channel pairings for the given example. This method has a tradeoff between WTRU selection/scheduling flexibility and Node-B codebook size. If restriction placed is too much on the possible channel pairings, i.e. put a low threshold on the correlation value, this may make the WTRU selection more difficult. But, it is expected that the channel pairings with ρ≧0.6533, 0.9061 are rarely used, so these may be omitted in the W computation. Another aspect of this approach is that an adaptive threshold selection may be used for ρ. When there are many active WTRUs in a system, due to the multi-WTRU diversity, channel pairings with smaller ρ values may be omitted.

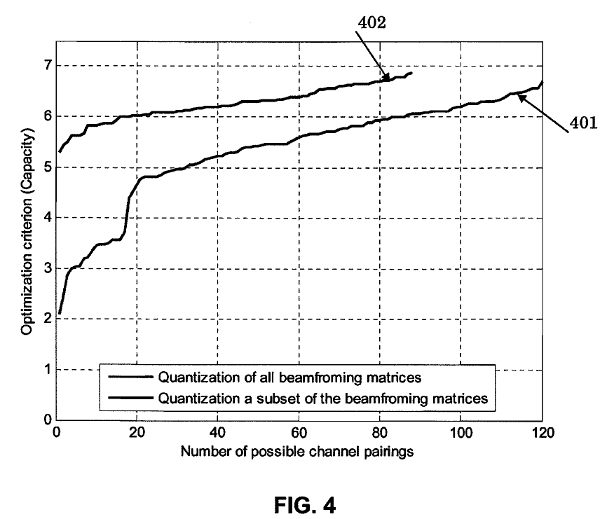

In a third embodiment, another efficient codebook design method is to design the Node-B codebook by combining the two embodiments outlined above. The channel pairings with high correlation values may be omitted; the Node-B codebook is computed and then quantized. The performance of this approach is illustrated with line 402 in FIG. 4. In this figure, the line 402 corresponds to the case where the channel pairings with ρ=0.6533, 0.9061 have been omitted before quantizing the Node-B codebook. This means that the quantization process may start with 88 possible channel pairings and beamforming matrices. The comparison of lines 401 and 402 in FIG. 4 shows that omitting the channel pairings with high correlation values and then quantizing the computed Node-B codebook results in an improved performance.

In a fourth embodiment, we describe a similar method for beamforming codebook quantization. In the techniques described above, the Node-B codebook was generated by using quantized channel pairs. In another approach, channel vectors that are not quantized are used to compute the Node-B codebook. For this purpose, a large number of channel vectors are randomly generated according to the statistics of the wireless channel. Here, the steps of the algorithm remain the same except that unquantized channel pairs H are used instead of the quantized channel pairs Ĥ. For example, Equations (9), (11) and (13), in this case, may be updated as Equations (14), (15), and (16), respectively:

$$\begin{matrix}{R}_{i} = \{ H \text{:} S I R ( H {\hat{W}}_{i} ) \geq S I R ( H {\hat{W}}_{j} ) , ∀ i \neq j \} , \\ i , j = 1 , … , N ; & Equation ( 14 ) \\ {R}_{i} = \{ H \text{:} C ( H {\hat{W}}_{i} ) \geq C ( H {\hat{W}}_{j} ) , ∀ i \neq j \} , \\ i , j = 1 , … , N ; & Equation ( 15 ) \\ {\hat{W}}_{i} = \frac{1}{{L}_{i}} {\sum }_{n = 1}^{{L}_{i}} {{H}_{n}^{H} ( {H}_{n} {H}_{n}^{H} )}^{- 1} , {H}_{n} ∈ {R}_{i} , \\ i = 1 , … , N . & Equation ( 16 )\end{matrix}$$

After the iterative algorithm converges, the resultant N beamforming matrices Ŵ are used as the codebook at the Node-B. The Node-B has to select the appropriate beamforming matrix to use after the WTRUs feed back their quantized channel information. This may be done according an optimality criterion such as capacity C (Ĥ Ŵ) or SIR SIR (Ĥ Ŵ). This selection can be kept in a mapping table such that for every possible quantized channel Ĥ the preferred beamforming matrix Ŵ is stored.

Performance of the Node-B quantization may be improved by grouping the channel matrices and applying the procedure separately to the different groups. The procedure works as follows. Separate all possible channel pairings into several groups such that in each group the correlations of the group members are similar. Then, compute the beamforming matrices in each group and quantize these matrices to create the Node-B codebook. Note that the total number of beamforming matrices has to be kept at N, so in each group we need to have a smaller number of beamforming matrices.

The proposed methods for codebook designs and codebook size reduction for Node-B ZF beamforming system may also be applied to minimum mean square error (MMSE) or other similar Node-B beamforming systems by considering the noise power or scaling factors in the beamforming matrices or vectors for the codebook designs.

The described techniques are used to reduce the number of beamforming matrices. An outcome of this result is that zero-forcing beamforming may be implemented by having the WTRU feed back the index of the preferred beamforming matrix instead of the quantized channel information. This is not possible when the number of beamforming matrices is large due to the large signalling overhead. The selection of the preferred beamforming matrix may be done by the WTRU according to an optimality criterion such as capacity or SIR. In this case, however, the WTRU may use the unquantized channel instead of the quantized channel.

FIG. 4 illustrates the output of the quantization algorithm based on the capacity criterion. The capacity by using the designed Node-B codebook and all possible channel pairings is sorted for ease of illustration and shown by line 401.

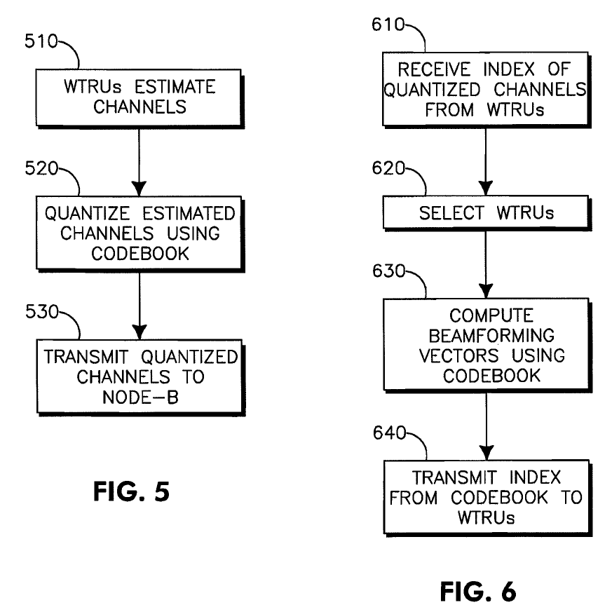

FIG. 5 shows a flow diagram illustrating an uplink control signalling. The WTRUs measure their channels to estimate the channels (510). A codebook is used to quantize the estimated channels (520). The quantized channels and a value of CQI are transmitted to the Node-B (530).

FIG. 6 shows a flow diagram illustrating a downlink control signalling. Node-B receives index of the quantized channels from the WTRUs (610). The Node-B then uses predetermined criteria to select the WTRUs for transmission (620). The Node-B computes the beamforming vectors using a codebook (630). An index from the codebook is transmitted to the WTRUs (640).

CQI Computation

A WTRU needs to feedback to the Node-B a CQI value as well as the quantized channel information. The CQI information is used to select WTRUs for transmission and possibly for adaptive modulation and coding. Here, the WTRU selection process is of interest. To compute the CQI, the WTRU has to first estimate its channel and then compute an approximate SINR. The SINR has to consider the inter-WTRU interference that is due to the other WTRUs scheduled simultaneously.

One method of computing the SINR is to use the lower bound introduced above in Equation (6),

$$E [ S I N {R}_{k} ] \geq \frac{{p}_{k} {‖ {h}_{k} ‖}^{2} {cos}^{2} {θ}_{k}}{1 + \frac{P}{M} {‖ {h}_{k} ‖}^{2} {sin}^{2} {θ}_{k}} ; \qquad Equation ( 17 )$$

where θₖ is the angle of the channel quantization error. Note that this approximation does not consider the effect of Node-B codebook quantization. Another possible CQI is the upper bound for the SINR, i.e.,

$$S I N {R}_{k} \leq \frac{{p}_{k} {‖ {h}_{k} ‖}^{2}}{{σ}^{2}}$$

which ignores the inter-WTRU interference and only considers the noise.

If the k^{th} WTRU has knowledge of quantized channel of the other simultaneous WTRU, it is able to compute the exact SINR as

$$S I N {R}_{k} = \frac{{p}_{k} {\vert {h}_{k} {w}_{k}^{*} \vert}^{2}}{{σ}^{2} + {\sum }_{i \neq k} {p}_{i} {\vert {h}_{k} {w}_{i}^{*} \vert}^{2}} ;$$

where w_{k,m} and w_{i,m} may be determined from the channel pairing to beamforming matrix mapping. But, the WTRU does not have any information about the interfering WTRU's channel. Nevertheless, it knows that the interfering WTRU's quantized channel may take 15 different values. For each of these possibilities it computes an SINR as in Equation (18),

$$S I N {R}_{k , m} = \frac{{p}_{k} {\vert {h}_{k} {w}_{k , m}^{*} \vert}^{2}}{{σ}^{2} + {\sum }_{i \neq k} {p}_{i} {\vert {h}_{k} {w}_{i , m}^{*} \vert}^{2}} \qquad Equation ( 18 )$$

where m=1, . . . , 15.

The number of possibilities may be reduced by omitting the channels whose correlations to ĥₖ are above a predetermined threshold. Once these SINRs are computed, then the CQI is determined as the average of these values, as follow:

$${CQI}_{k} = \frac{1}{M} {\sum }_{m = 1}^{M} S I N {R}_{k , m} . \qquad Equation ( 19 )$$

Alternatively, a weighted CQI computation may be used, i.e. give a larger weight to the SINR values that correspond to small correlation values because they would have larger probability of being paired.

Downlink Control Signalling

As a result of the quantization procedure, we produce a many-to-one mapping from the possible channel pairings to the beamforming matrices. For example, in the example used in the embodiments, each of the 120 channel pairings corresponds to one of the N beamforming matrices, where N may be 16. In this case, when the Node-B schedules two WTRUs whose quantized channel indexes are m and n respectively, such that Ĥ=[ĥₘ^{T}ĥₙ^{T}]^{T}, the index of the corresponding beamforming matrix is transmitted in the downlink control channel. If m>n, then the beamforming vectors in the matrix are interchanged. Due to the many-to-one mapping property, the scheduling gets simplified at the Node-B.

Also, it may be possible to reduce the downlink control channel overhead. For example, assume that although the channel pairings change over frequency or time, they correspond to the same beamforming matrix due to the many-to-one mapping. Then there is no need to send the full index of the beamforming matrix, so less information may be sent instead.

With the quantized channel information and the CQI value available at the Node-B, the WTRUs for transmission at Node-B are selected with the following algorithm: First choose the two WTRUs with the largest CQI values. If the correlation between the quantized channels of the selected WTRUs is below a threshold, find the beamforming matrix from the mapping table. Use the selected beamforming matrix for transmission. If the correlation is above the threshold, select the two WTRUs with the next largest CQIs and continue the steps of finding the beamforming matrix from the mapping table.

Node-B Codebook Based on FFT

The preferred method may also be applied to design codebooks that have a special structure. As an example, consider the design of the Node-B codebook that is based on FFT, similar to the WTRU codebook. This method may be extended to other codebooks, for example those that have constant modulus property.

In the codebook design algorithm given above, assume that an initial codebook of size N is selected from an FFT matrix. Then, to find the mapping from the quantized channel Ĥ to the preferred beamforming matrix, the first step of the Lloyd algorithm is performed. The algorithm is stopped at this point and does not proceed to the second step because it is preferred to retain the FFT based codebook. Once the mapping table that maps the quantized channel Ĥ to the preferred beamforming matrix element and the initial codebook are determined, the codebook may be used by the Node-B.

To find the optimal codebook based on FFT, start with a large number of possible initial codebooks, repeat the procedure described in the previous paragraph to find the mapping table and then use the codebook that results in the best performance as the final codebook.

Finding the optimal codebook by this method is computationally intensive because it requires an exhaustive search. However, this computation is done once and off-line. For the example used to explain the previous embodiments, the possible number of beamforming matrices computed from the FFT may, for example, be 240. These matrices are generated from the first M rows of a 16×16 FFT matrix where M is the number of transmit antennas at the Node-B. So, the initial codebook size is set to 240. After running the first step described based on FFT for a given number of channel pairings, (i.e., 88 in this case where channel pairings with high correlation are discarded), 74 regions are outputted where each region corresponds to a beamforming matrix. This means that computing the optimal Node-B codebook of size N needs a total of

$$( \begin{matrix}74 \\ N\end{matrix} )$$

comparisons.

The best performance of the FFT codebook may be achieved when using the Node-B codebook of size 74. Instead of comparing all possible

$$( \begin{matrix}74 \\ N\end{matrix} )$$

combinations, N matrices out of the 74 may be sub-optimally chosen so that the codebook size is decreased to N. In this case, by comparing several possible combinations the best one is chosen.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

1. A wireless transmit receive unit (WTRU) comprising:
a processor, the processor configured to estimate channel matrix of the WTRU, quantize estimated channels by using a codebook, and transmit an index of the quantized channels from the codebook along with a value of a channel quality indicator (CQI).

2. The WTRU as in claim 1, wherein the WTRU computes the CQI value by estimating its channel and determining a signal to interference plus noise ratio (SINR).

3. The WTRU as in claim 1, wherein the index is transmitted from the codebook to a Node-B.

4. The WTRU as in claim 3, wherein the CQI value is used by the Node-B to select at least one WTRU for transmission.

5. A method for a wireless transmit receive unit (WTRU) having a processor, the method comprising:
configuring the processor to estimate channel matrix of the WTRU;
quantizing estimated channels by using a codebook; and
transmitting an index of the quantized channels from the codebook along with a value of a channel quality indicator (CQI).

6. The method as in claim 5, wherein the WTRU computes the CQI value by estimating its channel and determining a signal to interference plus noise ratio (SINR).

7. The method as in claim 5, wherein the index is transmitted from the codebook to a Node-B.

8. The method as in claim 7, wherein the CQI value is used by the Node-B to select at least one WTRU for transmission.

9. A method for a Node-B computing beamforming vectors, comprising:
receiving an index of a quantized channel from wireless transmit receive units (WTRUs);
selecting at least one of the WTRUs for transmission;
computing beamforming vectors for the at least one selected WTRU; and
quantizing the beamforming vectors according to a codebook of the selected WTRU.

10. The method as in claim 9, further comprising transmitting an index of the quantized beamforming vectors from the codebook to the WTRUs.

11. The method as in claim 9, wherein the selecting selects the WTRUs that have orthogonal channels.

12. The method as in claim 9, wherein the selecting further comprising:
selecting the at least one WTRU that has a largest CQI value than the CQI values of the other WTRUs.

13. The method as in claim 12, further comprising,
calculating a beamforming matrix if a correlation between the quantized channels of selected WTRUs is below a predetermined threshold;
using the beamforming matrix for a transmission; and
selecting WTRUs with largest CQI values if a correlation between the quantized channels of the selected WTRUs is above a predetermined threshold.

14. A method for reducing size of a Node-B codebook, the method comprising:
identifying beamforming matrices from an initial codebook of the Node-B;
quantizing the initial Node-B codebook;
wherein the quantizing includes:
forming a region by associating a channel pairing with one of the beamforming matrices in the initial Node-B codebook;
computing a revised beamforming matrix for each region using the channel pairing associated with the beamforming matrix;
mapping the region to one of the revised beamforming matrices; and
generating a revised Node-B codebook that is reduced in size.

15. The method as in claim 14, wherein the channel pairing that exceed a predetermined threshold is omitted from the initial Node-B codebook.

16. The method as in claim 14, wherein the initial codebook is based on a Fast Fourier Transform (FFT).

17. The method as in claim 14, wherein the revised Node-B codebook is generated by using quantized channel pairs.

18. The method as in claim 14, wherein the revised Node-B codebook is generated by using channel pairs that are not quantized.

19. The method as in claim 14, wherein the initial Node-B codebook is quantized using a generalized Lloyd algorithm.

20. A method for reducing size of a codebook, the method comprising:
distributing channel pairings from an initial codebook into multiple groups;
computing beamforming matrices in each group; and
quantizing the matrices to create a revised codebook that is reduced in size.

21. The method as in claim 20, wherein each group of the multiple groups correlates to each other.

22. The method as in claim 20, wherein the initial codebook is based on a Fast Fourier Transform (FFT).

23. A method for reducing size of a codebook, the method comprising:
generating a codebook by computing all possible beamforming matrices;
quantizing the codebook; and
creating a revised codebook that is reduced in size.

24. The method as in claim 23, wherein the codebook that is reduced in sized is defined for both a wireless transmit receive unit (WTRU) and a Node-B.

25. The method as in claim 23, wherein the codebook is quantized using a generalized Lloyd algorithm.
